(19) United States
(12) Patent Application Publication
(10) Pub. No.: US 2014/0204608 A1
(43) Pub. Date: Jul. 24, 2014

(54) OPTICAL FILM HAVING AN ATYPICAL PATTERN, METHOD FOR MANUFACTURING THE SAME, AND BACKLIGHT ASSEMBLY TO WHICH THE OPTICAL FILM IS APPLIED

(71) Applicant: SEKONIX CO., LTD., Dongducheon (KR)

(72) Inventors: Jin Sung Park, Asan (KR); Gyu Hwan Hwang, Seoul (KR)

(73) Assignee: SEKONIX CO., LTD., Dongducheon (KR)

(21) Appl. No.: 14/220,813

(22) Filed: Mar. 20, 2014

Related U.S. Application Data
(63) Continuation of application No. PCT/KR2011/008031, filed on Oct. 26, 2011.

(30) Foreign Application Priority Data
Sep. 26, 2011 (KR) 10-2011-0096921
Sep. 26, 2011 (KR) 10-2011-0096927

(51) Int. Cl. F21V 8/00; G02B 5/02

(52) U.S. Cl. CPC G02B 6/0051; G02B 5/0221; G02B 5/0268
USPC 362/607; 359/599; 362/606; 264/2.5

(57) ABSTRACT

The present invention relates to an optical film having an atypical pattern, a method for manufacturing same and a backlight assembly including the optical film. The optical film of the present invention includes: a base layer transmitting light incident from outside; and a pattern layer formed on one or both sides of the base layer, and having a surface structured of a continuously formed polygonal optical pattern having an irregular size and arrangement. Thus, hot-spots and bright lines occurring at a light source and a light entering unit may be prevented. Not only can the pattern density of the optical film be maximized to improve brightness, but strong bright points may be effectively scattered and distributed through the atypical pattern to provide the effect of improved light-shielding ability, thereby contributing to a reduction in the number of expensive optical films used in a backlight assembly and an improvement in brightness.

### RELATED APPLICATIONS

This application is a continuation of PCT International Patent Application No. PCT/KR2011/008031, filed Oct. 26, 2011, which claims priority to Korean Patent Application Nos. 10-2011-0096921, filed Sep. 26, 2011, and 10-2011-0096927, filed Sep. 26, 2011. The contents of the foregoing applications are incorporated herein by reference.

### TECHNICAL FIELD

The present invention relates to an optical film having an atypical pattern, a method of manufacturing the same, and a backlight assembly using the optical film. More particularly, the present invention relates to an optical film having an atypical pattern, which can reduce hot spots and bright lines generated from a light source and a light entering unit and can improve brightness and brightness uniformity, a method of manufacturing the same, and a backlight assembly using the optical film.

### BACKGROUND ART

Recently, examining the development of surface light sources, direct-type and edge-type backlight assemblies using an LED lamp based on slim and low-power have actively been developed.

As conventional light sources of a backlight assembly, there are a cold cathode fluorescent lamp (CCFL) and a light emitting diode (LED), each of which is a point light source or line light source. Here, LED is suitable for stable life time and low-power consumption, but is problematic in that it is difficult to convert it into a surface light source for uniformly emitting light because it is similar to a point light source in terms of surface light source such as TV, monitors and the like.

Generally, in order to convert an LED into a surface light source that can apply uniform brightness to the entire surface of a display, a diffusion plate and a light guide plate are used.

However, even when the above diffusion plate and light guide plate are used, uniform light distribution is not completely achieved, and the loss of brightness of the original light source increases. Therefore, in order to compensate for the above problem, several sheets of expensive prism films and diffusion films must be used.

For this reason, in the field of manufacturing backlight assembly, it is required to develop an optical film having excellent light-shielding ability and excellent optical performance for the purpose of cost reduction and brightness improvement.

Generally, in order to provide light-diffusing and light-condensing functions to an optical film, hemispherical lenses or beads having a size of several micrometers˜several hundreds of micrometers (μm) and prism patterns are periodically arranged on the surface of the optical film.

However, when the optical film having such periodic arrangement overlaps an optical film having different periodic arrangement or a panel having pixels with a predetermined period, a moire phenomenon occurs due to geometric interference.

When a moire phenomenon occurs, unnecessary patterns are formed on an image realized on display, thus deteriorating image quality.

As a conventional method of preventing a moire phenomenon, there have been used a method of adjusting the size of a hemispherical lens to a pitch for minimizing moire in relation to an optical sheet, panel or the like having different periodic arrangement or pattern and a method of eliminating periodicity by changing the height or pitch of a lens.

However, the former method is problematic in that it cannot be used when an optical sheet, a display panel or the like is changed.

Further, the latter method can be usefully used for a prism sheet, but is problematic in that, in the case of a hemispherical diffusion film having a curved surface, when the pitch thereof is changed arbitrarily, the curved surface of a lens exposed to light is greatly changed, thus greatly increasing brightness. Further, this method is problematic in that the degree of difficulty of fabrication is relatively high.

As a conventional technology for preventing a moire phenomenon, Korean Patent Registration No. 10-0785379, as shown in FIG. 1, discloses an optical film, wherein the optical film is prepared by printing a micropattern 35 on a base film 30 to prevent a moire phenomenon and then forming a microprism pattern 25 thereon using molding.

However, this conventional technology is also problematic in that a process of printing a micropattern 35 on a base film 30 must be additionally performed in order to prevent a moire phenomenon, and in that it is limitedly applied to a prism sheet.

### DISCLOSURE

### Technical Problem

Accordingly, the present invention has been devised to solve the above-mentioned problems, and a first object of the present invention is to provide an optical film, which prevents a moire phenomenon occurring between a panel and an optical film and caused by an optical pattern shape, and forms an atypical pattern using a photolithography process to improve the density between patterns compared to a lens-type or bead-type diffusion sheet, thereby improving brightness.

A second object of the present invention is to provide a method of manufacturing an optical film having an atypical pattern, wherein the light-shielding ability of the optical film can be improved by effectively scattering and diffusing the light emitted from a lower light source.

A third object of the present invention is to provide a backlight assembly using the optical film having an atypical pattern, wherein this optical film serves to supply a light source to a display device, and can minimize the loss of brightness and can improve light-shielding ability.

### Technical Solution

In order to accomplish the above objects, an aspect of the present invention provides an optical film having an atypical pattern, including: a base layer transmitting incident light; and a pattern layer which is formed on one side or both sides of the base layer and which is configured to have atypical polygonal optical patterns having various sizes and irregularly arranged to have a structured surface.

Here, the optical patterns may be formed on the base layer by embossing or engraving.

Further, the optical patterns may be formed on the base layer to have embossed or engraved hemispheres, and the hemispheres may have various heights and refract light to diffuse or condense the light.

Further, the bottom shape of the optical pattern may be at least one combination of a pentagon, a hexagon, a heptagon and an octagon.

Further, the optical pattern may have a voronoi diagram shape, and may be configured such that, among optical pattern cells repeatedly or continuously arranged, some of the cells are atypical.

When the optical patterns are formed on one side of the base layer, the other side of the base layer may be additionally provided with prismatic patterns, hemispherical patterns or bead-shaped patterns.

Another aspect of the present invention provides a method of manufacturing an optical film having an atypical pattern, including the steps of: coating a base film with a photosensitive resin layer; disposing a photomask having a predetermined pattern over or under the photosensitive resin layer; irradiating the photosensitive resin layer with ultraviolet through the photomask to primarily cure the photosensitive resin layer; developing the primarily cured photosensitive resin layer; washing, drying and then irradiating the developed photosensitive resin layer with ultraviolet to secondarily cure the photosensitive resin layer, thus forming a master film having a master pattern; and manufacturing an optical film having an atypical optical pattern using the master film.

In the method, the master pattern formed on the photosensitive resin layer may be an embossed pattern or engraved pattern.

Further, the step of making an optical film having an atypical optical pattern using the master film can be performed by a general imprinting process.

Specifically, the step of making the optical film using the master film can be performed by a hard mold process in which the master film is made into a thin plate-shaped mold by electroforming, and then this thin plate-shaped mold is rolled on a cylindrical drum to be used in the step, and can be performed by a soft mold process in which the master film itself is used as a mold.

Preferably, a soft mold process, in which the master film carved with an atypical pattern is molded into a product by an imprinting process, is advantageous in terms of process simplification, productivity improvement and defective fraction reduction.

A process of manufacturing a product using a film carved with a predetermined pattern is referred to as a soft mold process in many patents and market. Thus, an apparatus for manufacturing a product using this soft mold process is generally used, and many companies are selling imprinting equipment, and thus it is not greatly difficult to manufacture a product using the master film.

Specifically, the process of making an optical film using the master film may include the steps of: injecting an ultraviolet-curable resin for imprinting between the master film having a mater pattern and a base film for manufacturing a product and then attaching the base film to the master film using a press roller; irradiating the base film with ultraviolet to cure the base film; separating the cured base film from the master film.

The base film may be a polyethylene terephthalate (PET) film, a polycarbonate (PC) film, a polystyrene (PS) film, an acrylic (AC) film or the like. These films may be used as the base film without limitation as long as they can be used for optics.

The ultraviolet-curable resin may be used without limitation as long as it can be cured by active energy beam such as ultraviolet, electron beam or the like. Specific examples of the ultra-curable resin may include polyesters, epoxy-based resins, polyester(meth)acrylate, epoxy(meth)acrylate, urethane(meth)acrylate, and the like. Among these resins, it is preferred that (meth)acrylate resin be used in terms of optical characteristics. Considering light condensing, it is preferred that the ultraviolet-curable resin have a refractive index of 1.24 to 1.60.

In terms of treatability and curability, the ultraviolet-curable resin may be prepared by mixing two or more materials selected from among ethoxylated bisphenol-A diacrylate, trimethylolpropane triacrylate, Irgacure, and Irganox.

Preferably, the ultraviolet-curable resin may be prepared by mixing all the four materials.

Specifically, the ultraviolet-curable resin may include 40˜80 wt % of ethoxylated bisphenol-A diacrylate, 0.5˜10 wt % of trimethylolpropane triacrylate, 0.5˜12 wt % of Irgacure, and 0.5˜12 wt % of Irganox, based on the total weight thereof. Here, ethoxylated bisphenol-A diacrylate is a UV-polymerized monomer, trimethylolpropane triacrylate is a monomer for adjusting the viscosity of ethoxylated bisphenol-A diacrylate, Irgacure is a UV-polymerization initiator, and Irganox functions as an antioxidant.

In order to improve the haziness of the optical film, the ultraviolet-curable resin may be mixed with any one selected from among titanium dioxide, aluminum, aluminum oxide, barium phosphate, calcium carbonate, calcium phosphate, magnesium phosphate, barium carbonate, zinc oxide, magnesium hydroxide, calcium hydroxide, talc and combinations thereof.

Still another aspect of the present invention provides a backlight assembly, including: a light source for emitting light; a light guide plate for guiding light emitted from the light source; a reflecting plate disposed under the light guide plate; and the above-mentioned optical disposed on the light guide plate.

### Advantageous Effects

As described above, according to the present invention, Not only can the pattern density of the optical pattern be maximized to improve brightness, but strong bright points may be effectively scattered and distributed through the atypical pattern to provide the effect of improved light-shielding ability, thereby contributing to a reduction in the number of expensive optical films used in a backlight assembly and an improvement in brightness values.

Further, the optical film of the present invention can be usefully applied to the improvement of light-shielding ability which is an important factor in a backlight assembly model.

Further, the optical film of the present invention can prevent a moire phenomenon occurring between a liquid crystal panel and another optical film, because it has an irregular optical pattern, that is, an atypical optical pattern.

### DESCRIPTION OF DRAWINGS

FIG. 1 is a plan view showing a conventional optical film including a base film printed with a micropattern and a resin layer provided with a prism pattern, wherein the base film and the resin layer are separated from each other.

FIG. 2 is a photograph showing an optical film having an atypical pattern according to an embodiment of the present invention.

FIG. 3 is a sectional view showing an optical film having an atypical pattern according to an embodiment of the present invention.

FIG. 4 is a process view showing a method of manufacturing an optical film having an atypical pattern according to the present invention.

FIG. 5 is a plan view showing a mask having an atypical pattern according to the present invention.

FIG. 6 shows sectional views of various optical films having an atypical pattern according to various embodiments of the present invention.

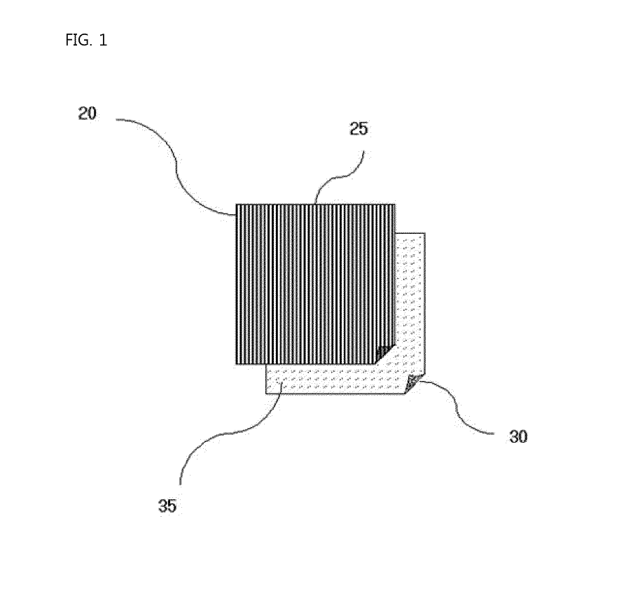

### MODE FOR INVENTION

The above and other objects, features and advantages of the present invention will be more clearly understood from the following detailed description taken in conjunction with the accompanying drawings. The present invention may be embodied in many different forms without departing from the spirit and significant characteristics of the invention. Therefore, the embodiments of the present invention are disclosed only for illustrative purposes and should not be construed as limiting the present invention. Unless otherwise defined, all terms including technical and scientific terms used herein have the same meaning as commonly understood by one of ordinary skill in the art to which this invention belongs. The terminology used herein is for the purpose of describing particular embodiments only and is not intended to be limiting. As used herein, the singular forms “a,” “an” and “the” are intended to include the plural forms as well, unless the context clearly indicates otherwise.

Hereinafter, preferred embodiments of the present invention will be described in detail with reference to the attached drawings.

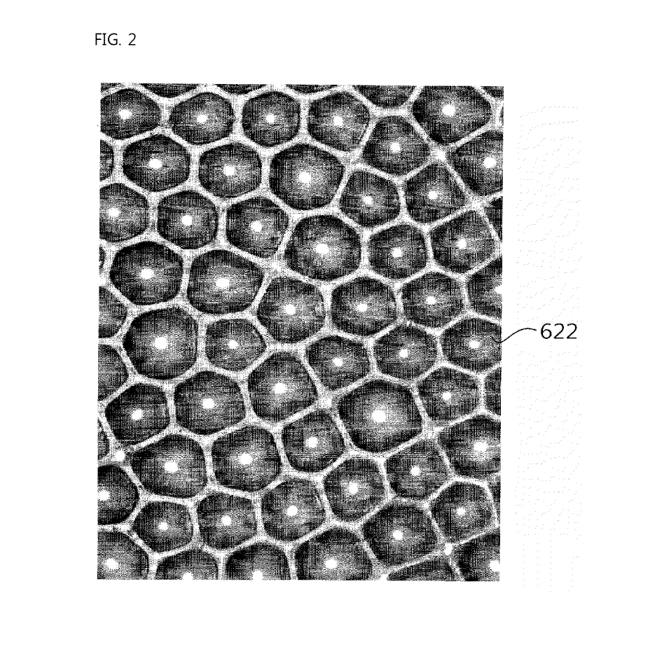

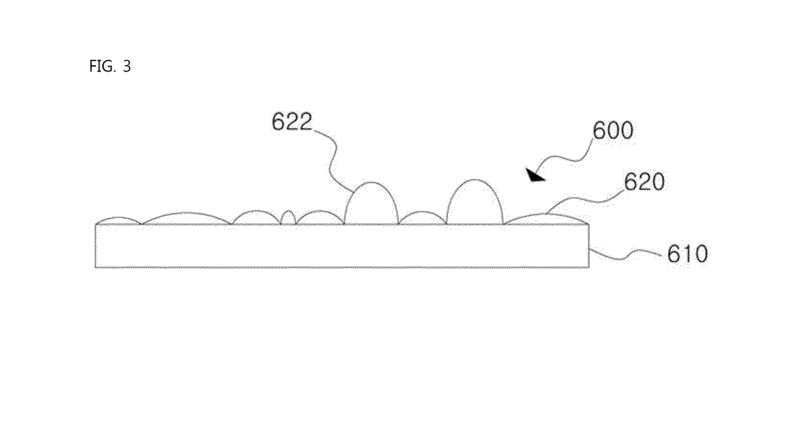

FIG. 2 is a photograph showing an optical film having an atypical pattern according to an embodiment of the present invention, and FIG. 3 is a sectional view showing an optical film having an atypical pattern according to an embodiment of the present invention.

The optical film 600 according to an embodiment of the present invention includes: a base layer 610 transmitting incident light; and a pattern layer 620 formed on one side or both sides of the base layer 610.

It is shown in FIG. 3 that the pattern layer 620 is formed only on the upper side of the base layer 610. However, this is an embodiment of the present invention, and the pattern layer 620 may be formed on one side of the base layer 610, that is, the upper side or lower side thereof, or may also be formed on both sides of the base layer 610.

As shown in FIG. 2, the pattern layer 620 is configured such that polygonal optical patterns 622 are continuously and irregularly arranged to have a structured surface.

The bottom shape of the optical pattern 622 may be at least one combination of a pentagon, a hexagon, a heptagon and an octagon.

Such an optical pattern 622 has an advantage of maximizing the pattern density of the optical film 600.

That is, a conventional optical film having prismatic patterns, hemispherical patterns or bead-shaped patterns is disadvantageous in that vacant spaces are formed among patterns, so uniform light distribution cannot be achieved, and the loss of brightness increases. In contrast, the optical film of the present invention is advantageous in that vacant spaces are not formed among patterns, that is, polygonal, such as pentagonal, hexagonal, heptagonal and octagonal patterns are continuously arranged, thus maximizing the pattern density of the optical film.

Moreover, the optical film of the present invention is advantageous in that the size and arrangement of the optical patterns 622 are irregular, that is, the optical pattern is an atypical pattern, and thus strong bright points are effectively scattered and distributed by the atypical pattern, thereby improving the light-shielding ability of the optical film.

That is, the optical patterns 622 of the present invention are configured such that they are not regularly formed in a typical polygonal shape, but are irregularly formed in size and arrangement, thus improving the pattern density thereof and scattering and distributing bright points.

Further, the optical patterns 622 may have a voronoi diagram shape, and may be configured such that, among optical pattern cells repeatedly or continuously arranged, some of the cells are atypical.

The size of the optical pattern 622 may be several micrometers (μm) to several hundreds of micrometers (μm). The size of the optical pattern 622 may be determined to be suitable for light diffusing and condensing functions, but is not limited.

The optical pattern 622 may be formed on the base layer 610 by embossing or engraving the base layer 610.

Here, the optical pattern 622 may be formed by embossing or engraving depending on the kind of a photosensitive material included in the following photosensitive resin layer. That is, the formation method of the optical pattern 622 is determined whether the photosensitive material of photoresist is a negative material or positive material.

Further, the optical patterns 622 are formed on the base layer 610 to have hemispheres.

In this case, the hemispheres may be formed in various heights. As such, in the case where the optical patterns 622 are formed to have hemispheres of various heights, the effects of diffusing and condensing light can be improved when light is refracted by the hemispheres.

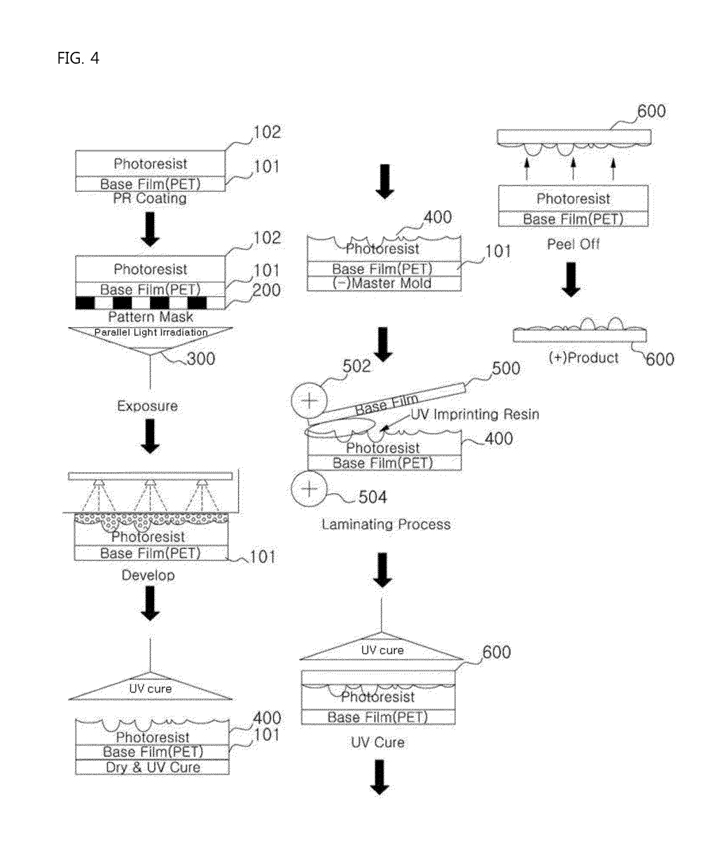

A method of manufacturing an optical film according to an embodiment of the present invention will be described with reference to FIG. 4. FIG. 4 is a process view showing a method of manufacturing an optical film having an atypical pattern according to the present invention.

Referring to FIG. 4, first, a photosensitive resin layer 102 is applied onto the surface of a base film 101.

Here, the photosensitive resin layer 102 can form various large-area patterns according to the shape of a photomask by radiation-polymerizing a photosensitive resin various refractive indices using UV lithography.

The photosensitive resin may be used without limitation as long as it can be used in optical lithography. Examples of the photosensitive resin may include radiation-curable epoxy acrylate, urethane acrylate, polyester acrylate, refractive index-adjusted derivative substitution, and the like. Preferably, SU-6 or SU-8 may be used as the photosensitive resin.

The method of forming the photosensitive resin layer 102 on the base film 101 using a photosensitive resin is not particularly limited, and may be performed by a commonly-known method.

A photomask 200 having a predetermined pattern is disposed over or under the photosensitive resin layer 102.

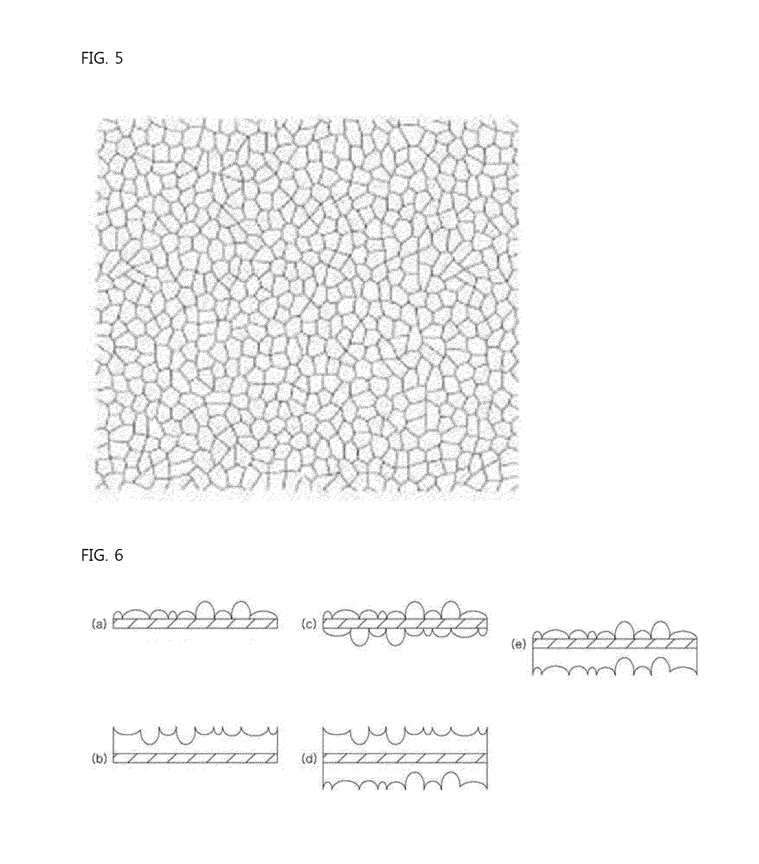

In the present invention, the photomask 200 has an atypical pattern, as shown in FIG. 5.

The photosensitive resin layer 102 irradiated with ultraviolet 300 through the photomask 200 to be primarily cured.

Thereafter, the primarily-cured photosensitive resin layer 102 is developed.

The photosensitive resin layer 102 is washed, dried and then irradiated with ultraviolet to be secondarily cured, thus forming a master film having a master pattern 400.

In the present invention, the master pattern 400 may be formed into an embossed pattern or an engraved pattern.

The embossed or engraved pattern is selectively formed depending on the kind of a photosensitive material included in photoresist. When the photosensitive material of photoresist is negative material, the light-received portion thereof is patterned, and, when the photosensitive material of photoresist is a positive material, the non-light-received portion thereof is patterned.

For example, a photosensitive resin (SU-8) is applied to the lower surface of a light guide plate or the upper surface of a PET film, irradiated with ultraviolet (UV), and then developed with an organic solvent such as PGMEA (Propylene Glycol Monomethyl Ether Acetate), GBL (gamma-butyrolactone), MIRK (methyl iso-butyl ketone) or the like, thereby obtaining a pattern.

Through the above procedures, an atypical master pattern 400 having irregular size and arrangement is formed on the base film 101.

Therefore, when the master pattern 400 formed in this way is transferred to a mold or is directly molded, an irregular diffusion pattern can be formed.

In an embodiment of the present invention, there is proposed an optical film having a diffusion pattern formed by directly molding the master pattern 400.

That is, in the step of manufacturing an optical film having an atypical optical pattern using a master film, an ultraviolet-curable resin is applied onto a master film 500 having a master pattern 400 to laminate the base film 500.

In this case, the lamination of the base film 500 is performed using press rollers 502 and 504.

Here, in order to improve the diffusion effect and haziness of the optical film, the ultraviolet-curable resin may be mixed with any one selected from among titanium dioxide, aluminum, aluminum oxide, barium phosphate, calcium carbonate, calcium phosphate, magnesium phosphate, barium carbonate, zinc oxide, magnesium hydroxide, calcium hydroxide, talc and combinations thereof.

The upper portion of the base film 500 is irradiated with ultraviolet to cure the ultraviolet-curable resin, thus obtaining an optical film 600.

The obtained optical film 600 is separated from the master film.

As described above, in the present invention, since a pattern is formed by a photolithography process, the height of a pattern can be adjusted by adjusting the UV radiation intensity in a UV exposure process or by adjusting the concentration, number of times and the like in a developing process. Therefore, atypical patterns having the same height may be formed on the entire surface of the base film, and, if necessary, atypical patterns having different heights may also be formed.

Consequently, the optical film of the present invention has an irregular surface structure causing no moire and maximizes the density among patterns, thus exhibiting excellent light diffusing and condensing functions.

FIG. 6 shows sectional views of various optical films having an atypical pattern according to various embodiments of the present invention.

That is, in an embodiment of the present invention, the optical patterns are formed on one side of the base layer by embossing. However, as shown in FIG. 6, the atypical optical patterns of the present invention may be formed on both sides of the base layer by embossing or engraving.

(b) Of FIG. 6 shows an atypical pattern formed on one side of the base layer by engraving, and (c) Of FIG. 6 shows atypical patterns formed on both sides of the base layer by embossing.

(d) Of FIG. 6 shows atypical patterns formed on both sides of the base layer by engraving, and (e) Of FIG. 6 shows atypical patterns formed on both sides of the base layer by a combination of embossing and engraving. As shown in (a) to (e) of FIG. 6, various types of atypical patterns may be formed.

Further, when an atypical pattern is formed on one side of the base layer by embossing, the other side of the base layer may be additionally provided with a prismatic, hemispherical or bead-shaped pattern.

Moreover, when a multilayered optical film is fabricated by laminating a plurality of optical films, at least one of the optical films may be the atypical optical film of the present invention.

The optical film of the present invention is used to constitute a backlight assembly.

The backlight assembly includes: a light source for emitting light; and the optical film of the present invention.

Here, the backlight assembly may further include: a light guide plate for guiding light emitted from the light source; and a reflecting plate disposed under the light guide plate.

As such, the backlight assembly including the optical film of the present invention is configured such that atypical patterns having various heights effectively scatter the light emitted from a lower light source to prevent a phenomenon in which the dotted patterns of the lower portion of an edge type light guide plate and the light emitted from a CCFL lamp or LED lamp of a direct type backlight assembly are observed as hot spots, thereby improving the light-shielding ability thereof.

Experimental data comparing the optical characteristics of the optical pattern of the present invention with those of a conventional optical pattern are given Table 1 below.

TABLE 1

| Production | Front → back | | Back → front | | |
|---|---|---|---|---|---|
| type | transmittance | haziness | transmittance | haziness | Brightness |
| Bead type | 98.0 | 78.8 | 81.2 | 78.1 | 100% |
| pattern | | | | | |
| Hemi- | 101.9 | 65.9 | 60.7 | 55.2 | 103% |
| spherical | | | | | |
| lens type | | | | | |
| pattern | | | | | |
| Atypical | 97.9 | 78.8 | 74.0 | 77.7 | 108% |
| pattern | | | | | |

From Table 1 above, it can be ascertained that the pattern density of the optical film of the present invention is maximized, thus greatly improving the brightness of the optical film of the present invention compared to that of a convention optical film having a bead-shape pattern or hemispherical lens-shaped pattern.

### INDUSTRIAL APPLICABILITY

When the optical film of the present invention is applied to a backlight assembly, the number of expensive optical films can be reduced, thus contributing to the cost reduction.

Further, the optical film of the present invention can be effectively applied to the improvement in the light-shielding ability of a backlight assembly including an LED which is similar to a point light source, and can contribute to the improvement in the brightness thereof. Therefore, the present invention has high industrial applicability.

1. An optical film having an atypical pattern, comprising:
a base layer transmitting incident light; and
a pattern layer which is formed on one side or both sides of the base layer and which is configured to have atypical polygonal optical patterns having various sizes and irregularly arranged to have a structured surface.

2. The optical film of claim 1, wherein the optical patterns are formed on the base layer by embossing or engraving.

3. The optical film of claim 2, wherein the optical patterns are formed on the base layer to have embossed or engraved hemispheres, and the hemispheres have various heights and refract light to diffuse or condense the light.

4. The optical film of claim 1, wherein the bottom shape of the optical pattern is at least one combination of a pentagon, a hexagon, a heptagon and an octagon.

5. The optical film of claim 1, wherein the optical pattern has a voronoi diagram shape, and is configured such that, among optical pattern cells repeatedly or continuously arranged, some of the cells are atypical.

6. The optical film of claim 1, wherein, when the optical patterns are formed on one side of the base layer, the other side of the base layer is additionally provided with prismatic patterns, hemispherical patterns or bead-shaped patterns.

7. A multilayered optical film, comprising a plurality of optical films, wherein at least one of the optical films is the optical film of any one of claims 1 to 6.

8. A method of manufacturing an optical film having an atypical pattern, comprising the steps of:
coating a base film with a photosensitive resin layer;
disposing a photomask having a predetermined pattern over or under the photosensitive resin layer;
irradiating the photosensitive resin layer with ultraviolet through the photomask to primarily cure the photosensitive resin layer;
developing the primarily cured photosensitive resin layer;
washing, drying and then irradiating the developed photosensitive resin layer with ultraviolet to secondarily cure the photosensitive resin layer, thus forming a master film having a master pattern; and
manufacturing an optical film having an atypical optical pattern using the master film.

9. The method of claim 8, wherein the master pattern formed on the photosensitive resin layer is an embossed pattern or engraved pattern.

10. The method of claim 8, wherein the light condensing and diffusing characteristics of the optical film are controlled by adjusting the density of atypical patterns per unit area by increasing or decreasing the line width of the photomask pattern depending on the characteristics of an applied backlight unit or the sheet structure thereof.

11. The method of claim 8, wherein, in order to improve the haziness of the optical film, the ultraviolet-curable resin is mixed with any one selected from among titanium dioxide, aluminum, aluminum oxide, barium phosphate, calcium carbonate, calcium phosphate, magnesium phosphate, barium carbonate, zinc oxide, magnesium hydroxide, calcium hydroxide, talc and combinations thereof.

12. A backlight assembly, comprising:
a light source for emitting light; and
the optical film of any one of claims 1 to 6.

13. The backlight assembly of claim 12, further comprising:
a light guide plate for guiding light emitted from the light source; and
a reflecting plate disposed under the light guide plate.
